(19) United States
(12) Patent Application Publication
(10) Pub. No.: US 2013/0121212 A1
(43) Pub. Date: May 16, 2013

(54) METHOD AND APPARATUS FOR SUPPORTING LOCATION-AWARE SERVICES

(71) Applicants: Arunabha Guha, Manalapan, NJ (US); Min Lu, Holmdel, NJ (US); Russell P. Sharples, East Windsor, NJ (US)

(72) Inventors: Arunabha Guha, Manalapan, NJ (US); Min Lu, Holmdel, NJ (US); Russell P. Sharples, East Windsor, NJ (US)

(21) Appl. No.: 13/296,915

(22) Filed: Nov. 15, 2011

(51) Int. Cl. H04L 12/66; H04L 12/16

(52) U.S. Cl. 370/259; 370/352

(57) ABSTRACT

A method, non-transitory computer readable medium and apparatus for processing a call setup message in a communications network. For example, the method receives the call setup message that includes called endpoint information, wherein the called endpoint information was previously inserted into the call setup message by a location server, processes the call setup message based upon the called endpoint information, and terminates the call setup message in accordance with the called endpoint information.

The present disclosure relates generally to terminating calls and, more particularly, to a method and apparatus for supporting location-aware services.

### BACKGROUND

Some voice services require an application server to know certain information before processing a call setup message. Currently, processing of the call setup message occurs before having such additional information that may be helpful in terminating the call setup message. As a result, processing of the call setup message in this way may lead to service inconsistency, degradation or incompatibility.

### SUMMARY

In one embodiment, the present disclosure provides a method, non-transitory computer readable medium and apparatus for processing a call setup message in a communications network. For example, the method receives the call setup message that includes called endpoint information, wherein the called endpoint information was previously inserted into the call setup message by a location server, processes the call setup message based upon the called endpoint information, and terminates the call setup message in accordance with the called endpoint information.

### BRIEF DESCRIPTION OF THE DRAWINGS

The teaching of the present disclosure can be readily understood by considering the following detailed description in conjunction with the accompanying drawings, in which:

FIG. 1 illustrates one example of a communications network of the present disclosure;

FIG. 2 illustrates an example flowchart of one embodiment of a method for supporting location-aware services in a communications network;

FIG. 3 illustrates an example flowchart of one embodiment of a method for generating a call setup message that contains called endpoint information such as location information and/or access information; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, non-transitory computer readable medium and apparatus for supporting location-aware services in a communications network. For some services in a communications network, there is a need for an application server to know certain information when initially processing a call set up message. For example, the information may be the physical location of a target device (e.g., a called endpoint device or handset such as a cellular phone or a smart phone), the technical capabilities of the target device and/or the network supporting the target device, and other situational information that can only be gathered from the target device.

However, some methods may process the call set up message without having any of the information described above. In other words, the call set up message is processed to the target device and then subsequently such information is collected. These methods may lead to service inconsistency, degradation or incompatibility. For example, these methods in processing a call set up message may cause the target device to ring, but once the necessary information is collected, the network may suddenly realize that the call should not have been processed, or detect an incompatibility and end the call abruptly. This illustrative scenario leads to an unsatisfactory user experience. To resolve these issues, the present disclosure provides a method, non-transitory computer readable medium and apparatus for supporting location-aware services in a communications network.

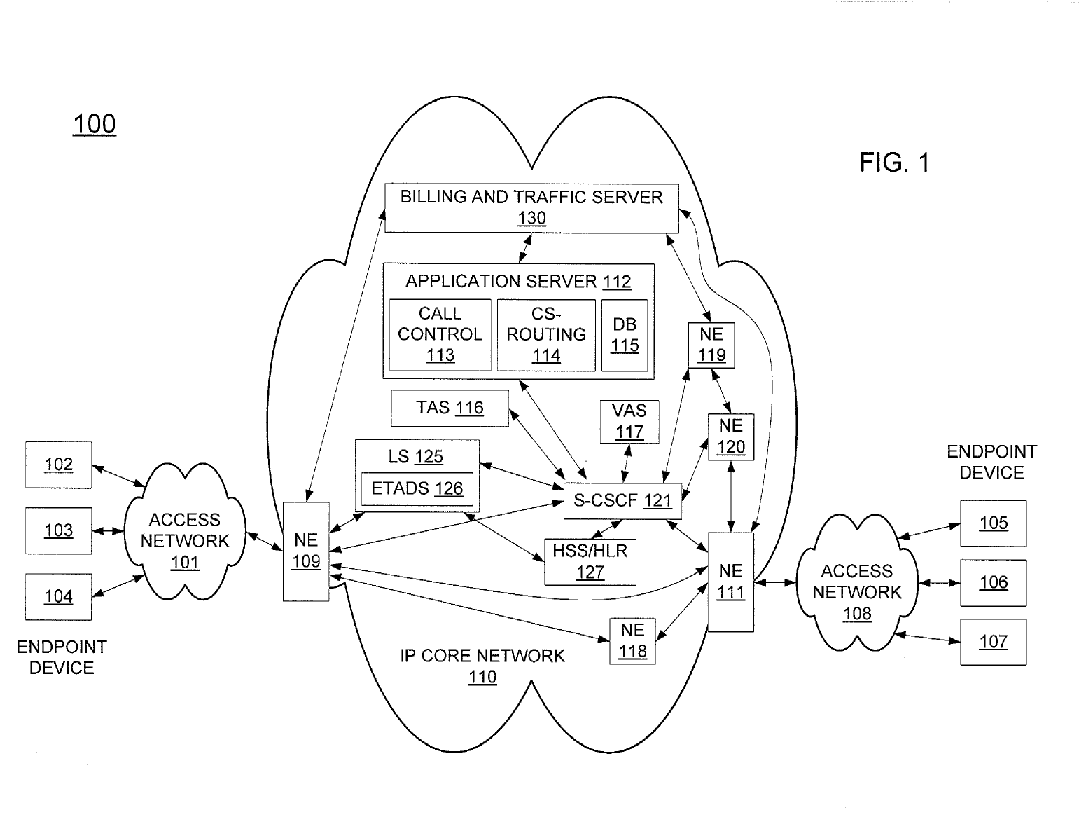

To better understand the present disclosure, FIG. 1 illustrates an example network 100, e.g., an Internet Protocol (IP) Multimedia Subsystem network related to the present disclosure. An IP network is broadly defined as a network that uses Internet Protocol to exchange data packets. Exemplary IP Multimedia Subsystem (IMS) networks include Internet Protocol (IP) networks such as Voice over Internet Protocol (VoIP) networks, Service over Internet Protocol (SoIP) networks, and the like.

In one embodiment, the network 100 may comprise a plurality of endpoint devices 102-104 configured for communication with the core IMS network 110 (e.g., an IP based core backbone network supported by a service provider) via an access network 101. Similarly, a plurality of endpoint devices 105-107 are configured for communication with the IMS core packet network 110 via an access network 108. The network elements (NEs) 109 and 111 may serve as gateway servers or edge routers for the network 110.

The endpoint devices 102-107 may comprise customer endpoint devices such as personal computers, laptop computers, Personal Digital Assistants (PDAs), mobile phones, smart phones, computing tablets, PBXs, aggregate endpoints (e.g., an aggregate endpoint that employs a SIP user agent to interact with the network on behalf of a plurality of endpoints aggregated behind it) and the like. The access networks 101 and 108 serve as a conduit to establish a connection between the endpoint devices 102-107 and the Network Elements (NEs) 109 and 111 of the IMS core network 110. The access networks 101 and 108 may each comprise a public land mobile network (PLMN), an Evolved packet Core 4^{th} generation Long Term Evolution (EPC 4G LTE) network, a 3G network, a 2G network, Digital Subscriber Line (DSL) network, a broadband cable access network, a Local Area Network (LAN), a Wireless Access Network, a 3^{rd} party network, and the like. The access networks 101 and 108 may be either directly connected to NEs 109 and 111 of the IMS core network 110, or indirectly through another network.

Some NEs (e.g., NEs 109 and 111) reside at the edge of the IMS core infrastructure and interface with customer endpoints over various types of access networks. An NE that resides at the edge of a core infrastructure is typically implemented as an edge router, a media gateway, a proxy server, a border element, a firewall, a switch, and the like. An NE may also reside within the network (e.g., NEs 118-120) and may be used as a SIP server, an application server, a core router, or like device.

In one embodiment, the IMS core network 110 also comprises a Home Subscriber Server/Home Location Register (HSS/HLR) 127 (broadly a subscriber register), a Serving-Call Session Control Function (S-CSCF) 121, a Location Server (LS) 125, a telephony application server (TAS) 116, a video application server (VAS) 117 and an Application Server 112. In one embodiment, the LS 125 may also include an enhanced terminating access domain selection (eTADS) function 126.

In one embodiment, the application server 112 may be a service centralization continuity application server (SCC-AS). The application server 112 may also include a call control function (SCC-call control) 113, a call routing function (CS_routing) 114 and a database (DB) 115. In one embodiment, the call control function 113 and the call routing function 114 may perform traditional call anchoring functions.

For a specific session, the S-CSCF of the calling party and the S-CSCF of the called party are also referred to as the originating S-CSCF and the terminating S-CSCF, respectively. The HSS/HLR 127 refers to a network element residing in the control plane of the IMS network that acts as a central repository of all customer specific authorizations, service profiles, preferences, etc. It should be noted that in one embodiment, the TAS 116 (or any other application server) may also have a database of customer specific authorizations, service profiles, preferences and etc.

The S-CSCF 121 resides within the IMS core infrastructure and is connected to various network elements (e.g., NEs 109 and 111) using the Session Initiation Protocol (SIP) over the underlying IMS based core backbone network 110. The S-CSCF 121 may be implemented to register users and to provide various services (e.g., VoIP services). The S-CSCF interacts with the appropriate VoIP/SoIP service related applications servers (e.g., 112, 116, 117 and 125), when necessary. The S-CSCF 121 performs routing and maintains session timers.

In one embodiment, the S-CSCF 121 uses initial filter criteria (iFCs—downloaded from the HSS 127) to determine the sequence of signaling that should occur. For example, based upon a user profile of the called endpoint or the type of call, the S-CSCF 121 may deploy the appropriate iFC. For example, if the call is a type of call that requires some called endpoint information, e.g., location information or technical capabilities information of the called endpoint, then the iFC that requires the LS 125 to be invoked first may be used. In another example, if the call does not require some called endpoint information to be used, the iFC that requires a typical call processing scenario where the AS 112 is invoked first may be used. In one embodiment, the present disclosure may modify the iFC such that the first line of the iFC obtains location information first, should the call processing be location dependent or capabilities dependent.

In order to complete a call that requires certain service specific features, the S-CSCF may need to interact with various application servers (e.g., various VoIP servers). For example, the S-CSCF may need to interact with another server for translation of an E.164 voice network address into an SIP URI, and so on. For example, the S-CSCF routes to a P-CSCF indicated by the SIP URI. The P-CSCF then routes to the SIP User Agent (UA) over a relationship that is established between the P-CSCF and the SIP UA which may represent an aggregate endpoint. This relationship could be a SIP trunk.

In one embodiment of the present disclosure, the location server (LS) is invoked before any feature service processing is performed, i.e., the location server (LS) is the first application server to be invoked before any other application servers such as TAS 116. For example, the LS 125 is a dedicated server that broadly obtains “called endpoint information” such as location information and/or access information, e.g., location information associated with the called endpoint, capability information associated with the called endpoint, and other types of information related to the called endpoint as discussed below. The LS 125 may support Diameter interface to HSS and an SS7 interface to HLR.

In one embodiment, the LS 125 may include the eTADS function 126 such that the LS 125 may interrogate the HSS/HLR 127 (broadly a subscriber register) to obtain called endpoint information such as a location of the called endpoint, access network (e.g., a cell site, a particular WiFi network, a particular WiFi hotspot, and so on) information of the called endpoint (e.g., whether the access network is VoIP capable, whether the access network is video capable and, if so, what quality it can support, etc.), technical capabilities of the called endpoint (e.g., whether the called endpoint can support video, the types of codecs the called endpoint is compatible with, e.g., G.711, G.728, G.729, etc.), routing information associated with the called endpoint, customer specific authorizations, service profiles, preferences, etc. The eTADS function 126 may then modify the call setup message such that the obtained information is included in the call setup message to the S-CSCF 121 and the AS 112 such that the call setup message may be processed correctly without having to obtain the called endpoint information again at a later time from the HSS/HLR 127. In one embodiment, if the call setup message is a session initiation protocol (SIP) invite message, then the body of the SIP invite message may be modified to include the obtained called endpoint information.

It should be noted that a customer may have a plurality of registered endpoint devices, e.g., a cell phone, a smart phone, a tablet computing device, a laptop computer and so on, where a call can be directed to all of these registered devices (e.g., in parallel or in a sequential manner). In one embodiment, the capabilities of these endpoints are also made known to the network. As such, called endpoint information of these devices can be obtained based on the requirement of a particular call. For example, a call that requires high definition video capability may only be supported by the smart phone and the tablet computing device (or alternatively only the access networks that are currently supporting these two devices at a particular moment in time are capable of high definition video). If that is the case, then only the called endpoint information of the smart phone and the tablet computing device are obtained and inserted into the call setup message.

The billing and traffic server 130 (broadly a billing server) is a dedicated server that tracks communication traffic for the purpose of generating bills to the customers of the service provider. For example, the billing and traffic server 130 is capable of tracking a large number of call parameters such as and not limited to: the number of calls, the duration of calls, the calling party numbers, the called party numbers, the types of call, and so on. These call parameters are processed and accounted by the billing and traffic server 130 so that proper bills are generated and provided to the customers of the service provider.

In one embodiment, the network elements that are involved in supporting a call will provide call handling information to the billing and traffic server 130. For example, the border elements (e.g., 109, and 111) that support a media path between a calling party (e.g., endpoint device 102) and a called party (e.g., endpoint device 105) will provide one or more call detail records (CDRs) to the billing and traffic server 130 upon termination of the call. Broadly, a CDR is a record produced by a network element containing details of a call that passed through it. CDR records and Cause Codes conform to an industry standard format.

The application server 112, the TAS 116, the VAS 117 and the LS 125 may comprise any server or computer that is well known in the art, and the database 115 may be any type of electronic collection of data that is also well known in the art. Those skilled in the art will realize that the communication network 100 may be expanded by including additional endpoint devices, access networks, network elements, application servers, etc. without altering the scope of the present disclosure.

It should be noted that the communication network 100 has been simplified. For example, the network 100 may include other network elements (not shown) such as border elements, routers, switches, call control elements, policy servers, security devices, a content distribution network (CDN) and the like.

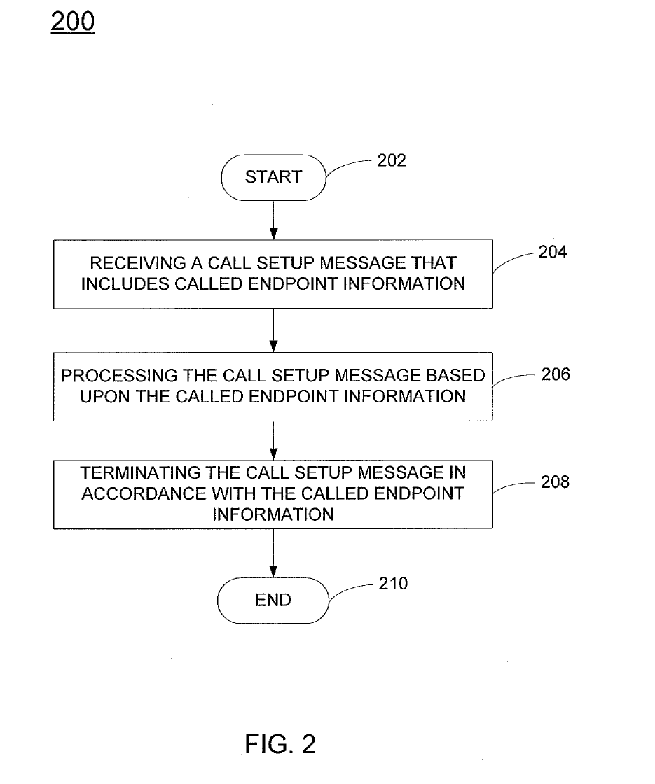

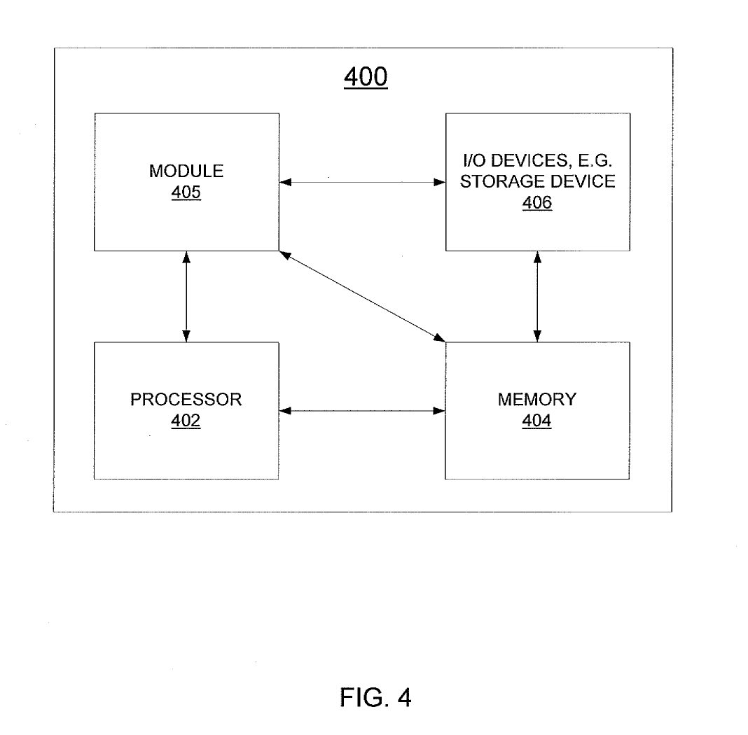

FIG. 2 illustrates a flowchart of a method 200 for supporting location-aware services in a communications network. In one embodiment, the method 200 may be performed by the application server 112 or a general purpose computer as illustrated in FIG. 4 and discussed below.

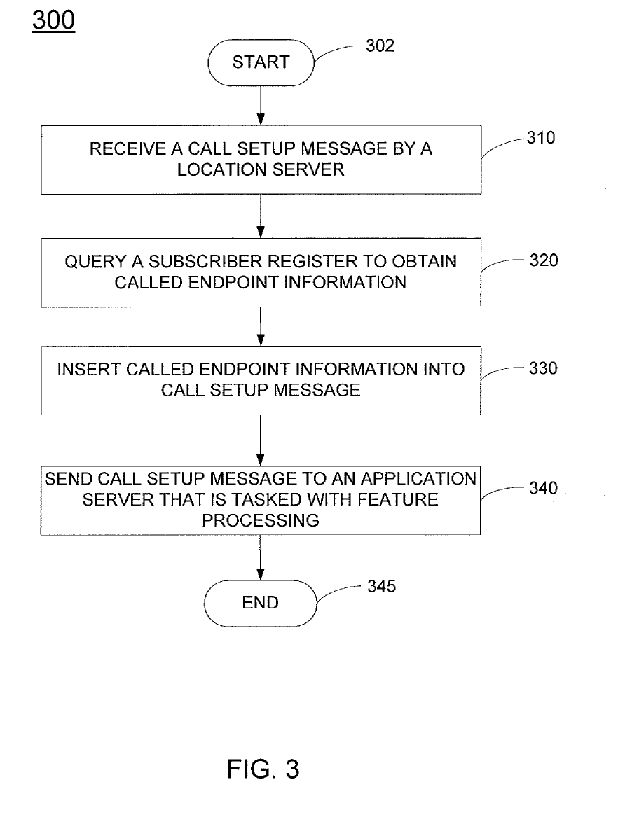

The method 200 begins at step 202. At step 204, the method 200 receives a call setup message that includes called endpoint information. It should be noted that the received the call setup message having the called endpoint information was previously generated by the location server as discussed below in FIG. 3. For example, the endpoint 102 may be attempting to call the endpoint 105, as illustrated in FIG. 1. In one embodiment, the call setup message may be a SIP INVITE message. In one embodiment, the call setup message may be for a voice call or may be for a multi-media service, e.g., a video call.

In one embodiment, as noted above, the method 200 may be performed by the AS 112. As a result, by receiving the called endpoint information with the call set up message, the AS 112 does not need to query or interrogate the HSS/HLR 127 at a later time during the processing. This allows the AS 112 to proceed with the call processing in a more efficient manner as the AS 112 may know whether or not the call should be completed and how the call should be completed based upon the called endpoint information. In one embodiment, the called endpoint information may include a location of the called endpoint, access network (e.g., a cell site, a particular WiFi network, a particular WiFi hotspot, and so on) information of the called endpoint, technical capabilities of the called endpoint, routing information associated with the called endpoint and the like.

In one embodiment, the called endpoint information is obtained by the LS 125 before the call setup message is provided to the TAS 116 or the VAS 117 (depending on whether the call setup message is for a voice call or a multi-media service) and the AS 112. The called endpoint information may then be appended into the body of the call setup message such that the called endpoint information may be processed by TAS 116 or the VAS 117 and the AS 112.

At step 206, the method 200 processes the call setup message based upon the called endpoint information. For example, some calls may be completed using a special or predefined feature associated with the call setup message that is dependent upon the called endpoint information. For example, the special feature may be a prepaid call, a time based (e.g., time based on the called endpoint location) billing arrangement for the called endpoint, a time based (e.g., time based on the called endpoint location) call forwarding of a called endpoint, a predetermined codec (e.g., based upon the technical capabilities of the called endpoint), a location based call handling feature and the like.

In one embodiment, a location based call handling feature may involve blocking calls to handsets in a defined geographic area, e.g., like a secure government facility, or forwarding such calls automatically to a voicemail server or to a central operator. Another example of a call handling feature may involve activating a simultaneous ringing feature of a home phone when the handset is detected to be on the home WiFi network. These are only several illustrations of possible location based call handling features.

As a result, by having the called endpoint information provided in the call setup message, it can be determined at the point of processing whether or not the call can be processed in accordance with the special feature associated with the call. For example, if the called endpoint has the technical capability to handle a call using a predetermined codec, the AS 112 may process and terminate the call in accordance with the special feature. However, if the called endpoint does not have the technical capability to handle the call using the predetermined codec, the AS 112 does not process the call and may terminate processing of the call immediately.

In another example, if the called endpoint has a predefined feature where it does not want to receive a call when the called endpoint is within certain geographical areas, the AS 112 may process and terminate the call in accordance with the predefined feature. Thus, if the called endpoint is determined to be within the predefined geographical areas, the AS 112 will not process the call and will terminate processing of the call immediately.

Currently, the call may be processed without knowing any of the called endpoint information discussed above. As a result, the called endpoint may ring or the calling endpoint may hear a ringing signal. After the call is processed, the AS 112 may obtain the called endpoint information. At which point, if the call cannot be completed, the call would be abruptly ended. This provides an unsatisfactory user experience.

However, using the present disclosure, the called endpoint and the calling endpoint would not hear ringing until the AS 112 knows that the call can be completed properly. As a result, if the call cannot be completed properly, the AS 112 may send a goodbye message to the calling endpoint before the calling endpoint or the called endpoint is to receive a ringing signal.

It should be noted that although the above step 206 is described as being performed by the AS 112, the present disclosure is not so limited. For example, in one alternate embodiment, the TAS 116 may be tasked with performing step 206.

At step 208, the method 200 terminates the call setup message in accordance with the called endpoint information. As discussed in the example above, if the call is associated with a special feature of a predetermined codec and the call can be terminated based upon the called endpoint information in the call setup message, then the method 200 terminates the call setup message using the called endpoint information. The method 200 then proceeds to step 210, where the method 200 ends.

FIG. 3 illustrates a flowchart of a method 300 for generating a call setup message that contains broadly called endpoint information such as location information and/or access information. In one embodiment, the method 300 may be performed by the location server 125 or a general purpose computer as illustrated in FIG. 4 and discussed below.

The method 300 begins at step 302. At step 310, the method 300 receives a call setup message, e.g., by a location server 125. For example, the endpoint 102 may be attempting to call the endpoint 105, as illustrated in FIG. 1. In one embodiment, the call setup message may be a SIP INVITE message. In one embodiment, the call setup message may be for a voice call or may be for a multi-media service, e.g., a video call.

At step 320, method 300 queries a subscriber register, e.g., an HSS/HLR or other database, for the called endpoint information. The called endpoint information may comprise location information and/or access information such as a location of the called endpoint, cell site information of the called endpoint (e.g., whether the access network is VoIP capable, whether the access network is video capable and, if so, what quality it can support, etc.), technical capabilities of the called endpoint (e.g., whether the called endpoint can support video, the types of codecs the called endpoint is compatible with, etc.), routing information associated with the called endpoint, customer specific authorizations, service profiles, preferences, etc.

At step 330, method 300 inserts the received called endpoint information into the call setup message. In one embodiment, the received called endpoint information is inserted into the body of the SIP INVITE message.

At step 340, method 300 sends the modified call setup message to an application server that is tasked with feature processing. In one embodiment, the modified call setup message is sent to TAS 116 for feature processing which is then forwarded to application server 112 for handling. Method 300 then ends in step 345.

It should be noted that the location server as discussed in method 300 is the first application server that is invoked. In other words, location server is invoked before any feature service processing is performed.

It should be noted that although not explicitly specified, one or more steps of the methods 200 and 300 described above may include a storing, displaying and/or outputting step as required for a particular application. In other words, any data, records, fields, and/or intermediate results discussed in the methods can be stored, displayed, and/or outputted to another device as required for a particular application.

FIG. 4 depicts a high-level block diagram of a general-purpose computer suitable for use in performing the functions described herein. As depicted in FIG. 4, the system 400 comprises a hardware processor element 402 (e.g., a CPU), a memory 404, e.g., random access memory (RAM) and/or read only memory (ROM), a module 405 for supporting location-aware services in a communications network, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed method. In one embodiment, the present module or process 405 for supporting location-aware services in a communications network can be loaded into memory 404 and executed by processor 402 to implement the functions as discussed above. As such, the present methods 405 for supporting location-aware services in a communications network (including associated data structures) of the present disclosure can be stored on a non-transitory computer readable storage medium, e.g., RAM memory, magnetic or optical drive or diskette and the like. For example, the processor 402 can be programmed or configured with instructions (e.g., computer readable instructions) to perform the steps of methods 200 and/or 300.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for processing a call setup message in a communications network, comprising:
receiving the call setup message that includes called endpoint information, wherein the called endpoint information was previously inserted into the call setup message by a location server;
processing the call setup message based upon the called endpoint information; and
terminating the call setup message in accordance with the called endpoint information.

2. The method of claim 1, wherein the call setup message comprises a session initiation protocol invite message.

3. The method of claim 2, wherein the called endpoint information is added to a body of the session initiation protocol invite message at the location server before performing a feature processing of the call setup message.

4. The method of claim 3, wherein the called endpoint information is obtained by the location server from a subscriber register.

5. The method of claim 1, wherein the called endpoint information comprises location information associated with the called endpoint.

6. The method of claim 1, wherein the called endpoint information comprises a technical capability associated with the called endpoint.

7. The method of claim 1, wherein the called endpoint information comprises access network information associated with the called endpoint.

8. The method of claim 1, wherein the called endpoint information comprises routing information.

9. The method of claim 1, wherein the processing comprises determining a predefined feature associated with the call setup message that is dependent upon the called endpoint information.

10. The method of claim 9, wherein the predefined feature comprises a time based billing feature.

11. The method of claim 9, wherein the predefined feature comprises a time based call forwarding feature.

12. The method of claim 9, wherein the predefined feature comprises a predetermined codec type.

13. The method of claim 9, wherein the predefined feature comprises a location based call handling feature.

14. A non-transitory computer-readable medium having stored thereon a plurality of instructions, the plurality of instructions including instructions which, when executed by a processor, cause the processor to perform a method for processing a call setup message in a communications network, comprising:
receiving the call setup message that includes called endpoint information, wherein the called endpoint information was previously inserted into the call setup message by a location server;
processing the call setup message based upon the called endpoint information; and
terminating the call setup message in accordance with the called endpoint information.

15. The non-transitory computer-readable medium of claim 14, wherein the call setup message comprises a session initiation protocol invite message, wherein the called endpoint information is added to a body of the session initiation protocol invite message at the location server before performing a feature processing of the call setup message.

16. The non-transitory computer-readable medium of claim 15, wherein the called endpoint information is obtained by the location server from a subscriber register.

17. The non-transitory computer-readable medium of claim 14, wherein the called endpoint information comprises location information associated with the called endpoint.

18. The non-transitory computer-readable medium of claim 14, wherein the called endpoint information comprises a technical capability associated with the called endpoint.

19. The non-transitory computer-readable medium of claim 14, wherein the called endpoint information comprises access network information associated with the called endpoint.

20. An apparatus for processing a call setup message in a communications network, comprising:
a processor configured to:
receive the call setup message that includes called endpoint information, wherein the called endpoint information was previously inserted into the call setup message by a location server;
process the call setup message based upon the called endpoint information; and
terminate the call setup message in accordance with the called endpoint information.
